(19) United States
(12) Patent Application Publication
(10) Pub. No.: US 2020/0125971 A1
(43) Pub. Date: Apr. 23, 2020

(54) INFORMATION PROCESSING APPARATUS AND GENERATION METHOD OF TIMING PATH LEARNING MODEL

(71) Applicant: FUJITSU LIMITED, Kawasaki-shi (JP)

(72) Inventor: Michitaka Hashimoto, Kawasaki (JP)

(73) Assignee: FUJITSU LIMITED, Kawasaki-shi (JP)

(21) Appl. No.: 16/576,835

(22) Filed: Sep. 20, 2019

(30) Foreign Application Priority Data
Oct. 19, 2018 (JP) 2018-197255

(51) Int. Cl. G06N 5/04; G06N 20/00

(52) U.S. Cl. CPC G06N 5/04; G06N 20/00

(57) ABSTRACT

An information processing apparatus includes a memory, and a processor coupled to the memory and configured to classify paths into ranges which are divided in a predetermined range unit and related to a coordinate value, based on a first feature amount that includes the coordinate value of a path, classify the paths into classes, based on a result of classifying the paths into the ranges and a second feature amount that includes a number of registers of the path, extract the path that has a maximum number of logic stages in each of the classes, and generate a timing path learning model that outputs a maximum limit value of a number of logic stages of a target path according to the first feature amount of the target path, based on training data that includes the number of logic stages and the first feature amount of the extracted path.

### CROSS-REFERENCE TO RELATED APPLICATION

This application is based upon and claims the benefit of priority of the prior Japanese Patent Application No. 2018-197255, filed on Oct. 19, 2018 the entire contents of which are incorporated herein by reference.

### FIELD

The embodiments discussed herein are related to an information processing apparatus and a generation method of a timing path learning model.

### BACKGROUND

In the related art, after a circuit configuration has been set in a field programmable gate array (FPGA), in order to check whether the circuit operates properly at a clock frequency required by a designer, a timing analysis is performed for a timing error factor analysis using a timing path learning model. The FPGA is, for example, a type of integrated circuit in which a buyer or a designer may internally set a desired circuit configuration after manufacture.

The timing path learning model is a model that indicates whether a target timing path is estimated to satisfy the timing constraint depending on the number of logic stages of the target timing path and outputs the number of logic stages of the target timing path permitted on the timing constraint. The timing path learning model is generated by machine learning, for example, based on teaching data (training data) on timing paths that satisfy the timing constraint.

As for the related art, there has been proposed, for example, a technique of reducing the number of teaching data by combining teaching data having a small distance based on a predetermined distance function to reconstruct new teaching data when other teaching data are added to preset the teaching data.

Related techniques are disclosed in, for example, Japanese Laid-open Patent Publication No. 04-184668.

### SUMMARY

According to an aspect of the embodiments, an information processing apparatus includes a memory, and a processor coupled to the memory and configured to classify a plurality of paths into a plurality of ranges which are divided in a predetermined range unit and related to a coordinate value, based on a first feature amount that includes the coordinate value of a path of the plurality of paths, classify the plurality of paths into a plurality of classes, based on a result of classifying the plurality of paths into the plurality of ranges and a second feature amount that includes a number of registers of the path, extract the path that has a maximum number of logic stages in each of the plurality of classes, and generate a timing path learning model that outputs a maximum limit value of a number of logic stages of a target path according to the first feature amount of the target path, based on training data that includes the number of logic stages and the first feature amount of the extracted path.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory view illustrating an example of a generation method according to an embodiment;

FIG. 2 is a block diagram illustrating an example of the hardware configuration of an information processing apparatus 100;

FIG. 3 is an explanatory view illustrating an example of storage contents of a path information table 300;

FIG. 4 is an explanatory view illustrating an example of storage contents of a delay information table 400;

FIG. 5 is an explanatory view illustrating an example of storage contents of a threshold information table 500;

FIG. 6 is a block diagram illustrating an example of the functional configuration of the information processing apparatus 100;

FIG. 7 is an explanatory view (part 1) illustrating an example of generating a model;

FIG. 8 is an explanatory view (part 2) illustrating an example of generating a model;

FIG. 9 is an explanatory view (part 3) illustrating an example of generating a model;

FIG. 10 is an explanatory view illustrating an example of using a model for timing analysis;

FIG. 11 is an explanatory view (part 1) illustrating an example of setting a predetermined range;

FIG. 12 is an explanatory view (part 2) illustrating an example of setting a predetermined range;

FIG. 13 is an explanatory view (part 3) of an example of setting a predetermined range; and

FIG. 14 is a flowchart illustrating an example of the entire processing procedure.

### DESCRIPTION OF EMBODIMENTS

In the related art, it is difficult to efficiently generate an accurate timing path learning model by machine learning. For example, when the number of teaching data is increased, the processing amount and processing time required to generate the timing path learning model may be increased. Further, increasing the number of teaching data does not necessarily improve the accuracy of the timing path learning model.

Hereinafter, an embodiment of a technique of efficiently generating a timing path learning model will be described in detail with reference to the accompanying drawings.

[Example of Generation Method According to Embodiment]

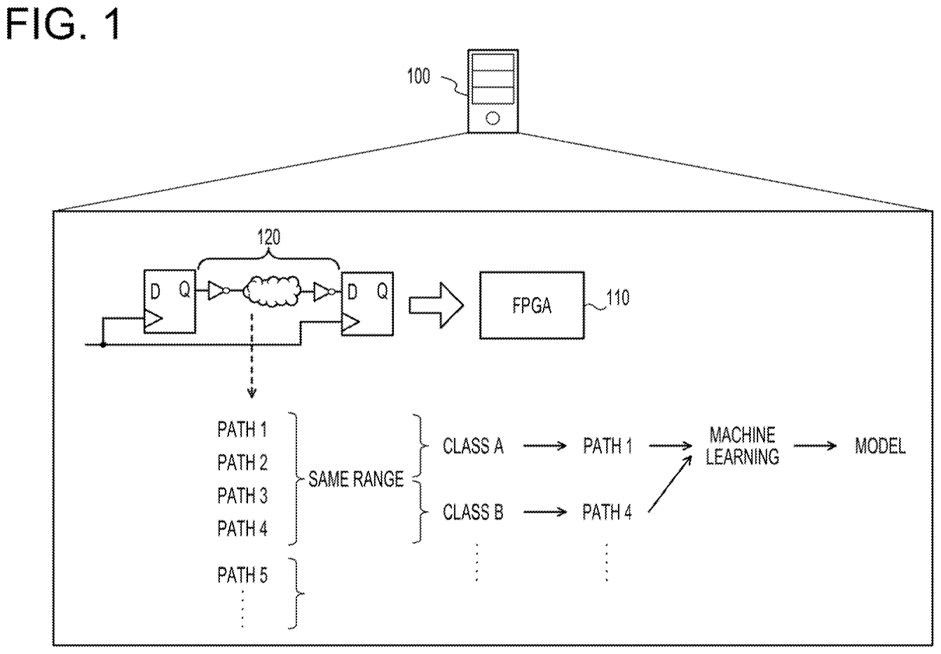

FIG. 1 is an explanatory view illustrating an example of a generation method according to an embodiment. An information processing apparatus 100 is a computer that supports a timing analysis on a target circuit icy implemented by using an FPGA, The information processing apparatus 100 is, for example, a server or a personal computer (PC).

In the related art, there has been a case where a timing analysis for a circuit of interest is performed manually. In this case, the work load and work time required for an analyst performing the timing analysis increase along with the increase in circuit scale. In addition, the analyst may not perform the timing analysis with high accuracy when the skill level of timing analysis of the analysis is not sufficient.

For this reason, it is desirable to use a machine learning to support the timing analysis. For example, a technique of using a machine learning to generate a timing path learning model and supporting the timing analysis with the timing path learning model may be considered. The timing path learning model is a model that indicates whether a target timing path is estimated to satisfy the timing constraint depending on the number of logic stages of the target timing path, and outputs the number of logic stages of the target timing path permitted on the timing constraint. The timing constraint is a range in which the signal delay amount of a timing path is allowed, and is a condition indicating that a circuit including the timing path may operate properly.

However, it is difficult to efficiently generate an accurate timing path learning model. For example, when the number of teaching data on a timing path that satisfies a timing constraint, which are used for machine learning, is too small, the accuracy of a generated timing path learning model is deteriorated, Specifically, a timing path learning model may be generated by learning the number of logic stages that does not satisfy the timing constraint as the number of logic stages permitted on the timing constraint. As a result, in the timing analysis that utilizes a timing path learning model, there is a possibility that a timing path which does not actually satisfy the timing constraint may be determined as a timing path that satisfies the timing constraint, which may lead to a decrease in timing analysis accuracy.

In the meantime, it is conceivable to increase the number of teaching data on a timing path that satisfies the timing constraint, which are used for machine learning. However, the increased number of teaching data results in an increase in processing amount and processing time required to generate a timing path learning model. Specifically, when the number of teaching data is about 10,000 to 30,000, the processing time required to generate a timing path learning model is about 7 to 10 days. In recent years, the Time to Market tends to become short, and therefore, it is not preferable to cause an increase in processing amount and processing time required to generate a timing path learning model.

Further, increasing the number of teaching data does not necessarily improve the accuracy of the timing path learning model. Specifically, it is conceivable to use a Support Vector Machine (SVM) for machine learning. In this case, a timing path learning model is generated by learning the representative value of the number of logic stages that satisfies the timing constraint obtained by a square error minimization, instead of the maximum value of the number of logic stages satisfying the timing constraint, as the number of logic stages permitted on the timing constraint. As a result, in the timing analysis using a timing path learning model, there is a possibility that a timing path which actually satisfies the timing constraint may be determined as a timing path which does not satisfy the timing constraint, which causes a decrease in the accuracy of timing analysis.

The present embodiment provides a generation method capable of reducing the number of teaching data that is used for generation of a model capable of outputting the maximum value of the number of logic stages of a target timing path according to the feature amount of the target timing path. In the following description, a timing path may be simply referred to as a “path”.

In the example of FIG. 1, the information processing apparatus 100 stores path feature amounts of each of a plurality of paths. The plurality of paths satisfy a timing constraint. A path is a route through which a signal flows. The path is, for example, a route 120 between the registers. The path is implemented in, for example, an FPGA 110. Specifically, the path is implemented using elements of the FPGA 110.

The feature amount of the path includes, for example, a first feature amount related to a coordinate value of an element of the path. The first feature amount is, for example, an amount obtained by statistically processing the coordinate value of the element of the path. Specifically, the first feature amount is an average value of coordinate values of elements of the path. The coordinate value is, for example, a value indicating a position on the FPGA 110. In addition, the path feature amount includes a second feature amount that is different from the first feature amount. The second feature amount has no relationship to the coordinate values of the elements of the path. The second feature amount includes at least one of, for example, the number of registers of the path, the number of lookup tables of the path, and the frequency of a signal of the path.

In addition, the information processing apparatus 100 stores a plurality of ranges regarding coordinate values divided into predetermined range units. Each of the plurality of ranges is used as a classification destination of a path based on the first feature amount. Each of the plurality of ranges is a range in which a difference in the first feature amount between paths classified into the same range may be ignored from the viewpoint of signal delay involved in timing analysis. Each of the plurality of ranges is a range in which the influence of the difference in the first feature amount on the signal delay is estimated to be smaller than the influence on the signal delay when the number of logic stages is increased by one. The predetermined range is, for example, a predetermined width regarding coordinate values. The predetermined range is, for example, set either manually or automatically to define a plurality of ranges.

(1-1) The information processing apparatus 100 classifies a plurality of paths into a plurality of ranges regarding coordinate values based on the first feature amount of each of the plurality of paths. For example, when the first feature amounts of paths 1 to 4 are included in the same range, the information processing apparatus 100 classifies the paths 1 to 4 into the same range.

(1-2) The information processing apparatus 100 classifies the plurality of paths into a plurality of classes based on the result of classification of the plurality of paths into the plurality of ranges and the second feature amount of each path. For example, when the second feature amounts of the paths 1 and 2 are the same, the information processing apparatus 100 classifies the paths 1 and 2 into the same class A. For example, when the second feature amounts of the paths 3 and 4 are the same, the information processing apparatus 100 classifies the paths 3 and 4 into the same class B.

(1-3) The information processing apparatus 100 extracts a path having the largest number of logic stages in each of the plurality of classes. The information processing apparatus 100 extracts the path 1 having the largest number of logic stages in the class A. Further, the information processing apparatus 100 extracts the path 4 having the largest number of logic stages in the class B.

(1-4) The information processing apparatus 100 generates a model by using the number of logic stages and the feature amount of the extracted path as teaching data. The teaching data includes input data and correct answer data corresponding to the input data. For example, the teaching data includes the feature amount of the extracted path as the input data and includes the number of logic stages of the extracted path as the correct answer data. The model outputs the upper limit value of the number of logic stages of a target path according to the feature amount of the target path. The information processing apparatus 100 generates a model using, for example, the number of logic stages and the feature amounts of the extracted paths 1 and 4 as teaching data.

Thus, the information processing apparatus 100 may efficiently generate a model capable of outputting the upper limit value of the number of logic stages of the target path with high accuracy according to the feature amount of the target path.

For example, the information processing apparatus 100 may use the number of logic stages and the feature amount of a path extracted from each of a plurality of classes into which a plurality of paths is classified, as teaching data, without using the number of logic stages and the feature amounts of all of the plurality of paths as teaching data. Therefore, the information processing apparatus 100 may, for example, reduce the number of teaching data used to generate a model, and may reduce the processing amount and the processing time required to generate the model. The information processing apparatus 100 may also reduce the power consumption required to generate the model.)

Further, when classifying a plurality of paths into a plurality of classes, the information processing apparatus 100 may ignore a difference in the first feature amount from the viewpoint of signal delay involved in timing analysis, and also may combine paths having the same second feature amount into the same class. For this reason, when the information processing apparatus 100 extracts at least a path having the largest number of logic stages from each of a plurality of classes and uses the number of logic stages and the feature amount of the extracted path as teaching data, the model accuracy may be secured.

Then, the information processing apparatus 100 may make the generated model available for timing analysis. For example, the information processing apparatus 100 may make the generated model available for timing error factor analysis. As a result, the information processing apparatus 100 may improve the accuracy of the timing analysis by a highly accurate model. Further, the information processing apparatus 100 may improve the accuracy of the timing analysis regardless of an analysts skill level of timing analysis. In addition, the information processing apparatus 100 may reduce the workload on the analyst. Further, the information processing apparatus 100 may reduce the time required for physical design of a circuits.

Although descriptions have been made on the case where the information processing apparatus 100 stores the first feature amount as the path feature amount, the present disclosure is not limited thereto. For example, the information processing apparatus 100 may store a coordinate value of an element of a path as the feature amount of the path and may calculate the first feature amount. Further, although descriptions have been made on the case where the information processing apparatus 100 stores a plurality of ranges, the present disclosure is not limited thereto. For example, the information processing apparatus 100 may store a predetermined range and set a plurality of ranges automatically.

[Hardware Configuration Example of Information Processing Apparatus 100]

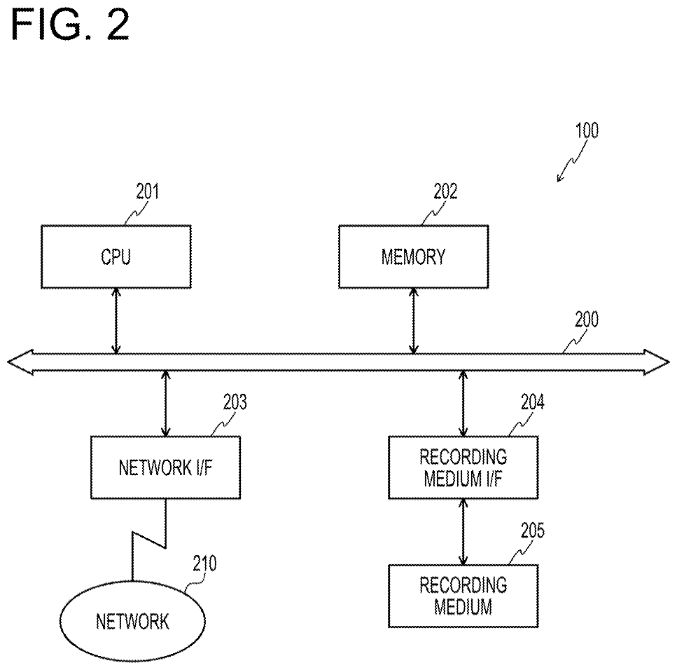

Next, a hardware configuration example of the information processing apparatus 100 will be described with reference to FIG. 2.

FIG. 2 is a block diagram illustrating an example of the hardware configuration of the information processing apparatus 100, As illustrated in FIG. 2, the information processing apparatus 100 includes a central processing unit (CPU) 201, a memory 202, a network Interface (I/F) 203, a recording medium I/F 204, and a recording medium 205, which are interconnected by a bus 200.

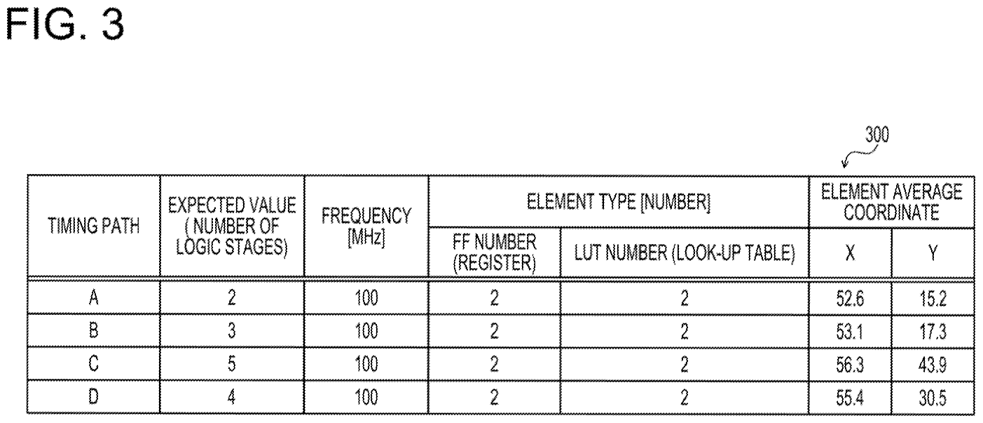

Here, the CPU 201 is in charge of controlling the entire information processing apparatus 100. The memory 202 includes, for example, a read only memory (ROM), a random access memory (RAM), a flash ROM, and the like, Specifically, for example, the flash ROM or the ROM stores various programs, and the RAM is used as a work area of the CPU 201. The programs stored in the memory 202 are loaded into the CPU 201 to cause the CPU 201 to execute a coded process. The memory 202 stores, for example, various tables which will be described later with reference to FIGS. 3 to 5.

The network I/F 203 is connected to a network 210 via a communication line, and is connected to other computers via the network 210. The network I/F 203 takes a role of an internal interface with the network 210 and controls input/output of data from other computers. The network I/F 203 is, for example, a modem or a local area network (LAN) adapter.

The recording medium I/F 204 controls reading/writing of data from/in the recording medium 205 according to the control of the CPU 201. The recording medium I/F 204 is, for example, a disk drive, a solid state drive (SSD), a universal serial bus (USB) port, or the like. The recording medium 205 is a nonvolatile memory that stores data written under control of the recording medium I/F 204. The recording medium 205 is, for example, a disk, a semiconductor memory, a USB memory, or the like. The recording medium 205 may be removable from the information processing apparatus 100s The recording medium 205 may store, for example, various tables to be described later with reference to FIGS. 3 to 5.

The information processing apparatus 100 may include, for example, a keyboard, a mouse, a display, a printer, a scanner, a microphone, a speaker, and the like in addition to the above-mentioned components. Further, the information processing apparatus 100 may include a plurality of recording medium I/Fs 204 and a plurality of recording media 205. Further, the information processing apparatus 100 may not include the recording medium I/F 204 and the recording medium 205.

[Storage Contents of Path Information Table 300]

Next, an example of storage contents of a path information table 300 will be described with reference to FIG. 3. The path information table 300 is implemented, for example, by a storage area of the memory 202 or the recording medium 205 of the information processing apparatus 100 illustrated in FIG. 2.

FIG. 3 is an explanatory view illustrating an example of the storage contents of the path information table 300, As illustrated in FIG. 3, the path information table 300 has fields for a timing path, an expected value, a frequency, an element type, and an element average coordinate. The path information table 300 stores path information as a record by setting information in each field for each path.

Information for identifying a path that satisfies the timing constraint is set in the field of timing path. The number of logic stages of the path is set in the field of expected value. The frequency of a signal of the path is set in the field of frequency. The unit of frequency is, for example, MHz.

The field of element type further includes fields for a Flip Flop (FF) number and a Look-Up Table (LUT) number. The number of registers of a path is set in the field of FF number. The number of lookup tables of the path is set in the field of LUT number. The field of element average coordinate further includes fields of X and Y. An average value of X coordinate values of elements of the path is set in the field of X. An average value of Y coordinate values of elements of the path is set in the field of Y.

[Storage Contents of Delay Information Table 400]

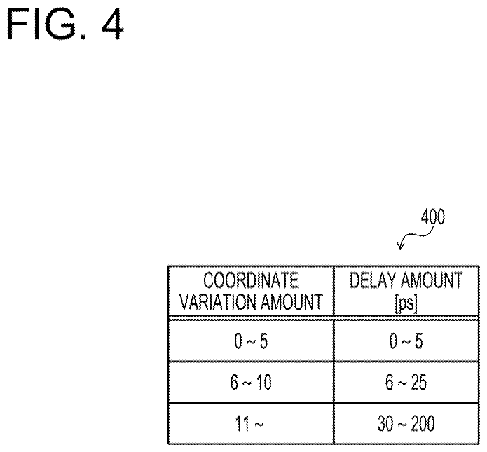

Next, an example of storage contents of a delay information table 400 will be described with reference to FIG. 4, The delay information table 400 is implemented, for example, by a storage area of the memory 202 or the recording medium 205 of the information processing apparatus 100 illustrated in FIG. 2.

FIG. 4 is an explanatory view illustrating an example of the storage contents of the delay information table 400. As illustrated in FIG. 4, the delay information table 400 has fields for a coordinate variation amount and a delay amount. The delay information table 400 stores delay information as a record by setting information in each field for each coordinate variation amount.

A range of variation amount of the first feature amount related to a coordinate value is set in the field of coordinate variation amount. For example, a range of variation amount of an element average coordinate is set in the field of coordinate variation amount. A range of variation amount of delay amount when the first feature amount is varied is set in the field of delay amount. The unit of the delay amount is ps.

[Storage Contents of Threshold Information Table 500]

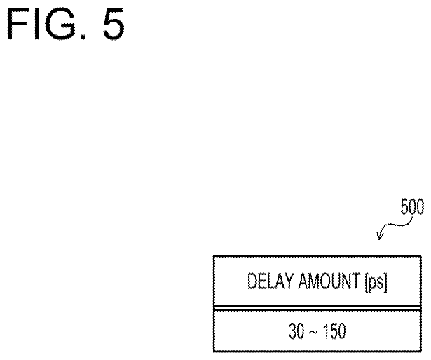

Next, an example of storage contents of a threshold information table 500 will be described with reference to FIG. 5. The threshold information table 500 is implemented, for example, by a storage area of the memory 202 or the recording medium 205 of the information processing apparatus 100 illustrated in FIG. 2.

FIG. 5 is an explanatory view illustrating an example of the storage contents of the threshold information table 500. As illustrated in FIG. 5, the threshold information table 500 has a field for delay amount. The threshold information table 500 stores threshold information as a record by setting information in the field. A range of variation amount of delay amount when the number of logic stages is increased by one is set in the field of delay amount. The unit of the delay amount is ps. [Functional Configuration Example of Information Processing Apparatus 100]

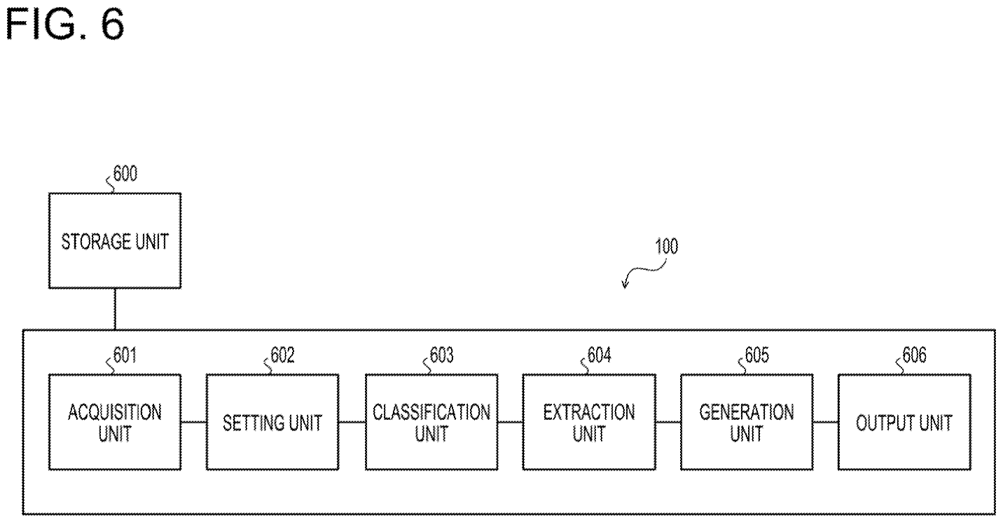

Next, a functional configuration example of the information processing apparatus 100 will be described with reference to FIG. 6.

FIG. 6 is a block diagram illustrating an example of the functional configuration of the information processing apparatus 100. The information processing apparatus 100 includes a storage unit 600, an acquisition unit 601, a setting unit 602, a classification unit 603, an extraction unit 604, a generation unit 605, and an output unit 606.

The storage unit 600 is implemented by, for example, a storage area of the memory 202 or the recording medium 205 illustrated in FIG. 2. Although descriptions will be made below on a case where the storage unit 600 is included in the information processing apparatus 100, the present disclosure is not limited thereto. For example, the storage unit 600 may be included in an apparatus different from the information processing apparatus 100, and the storage unit 600 may be configured such that the information processing apparatus 100 refers to the storage contents of the storage unit 600.

The acquisition unit 601, the setting unit 602, the classification unit 603, the extraction unit 604, the generation unit 605, and the output unit 606 function as an example of a controller. Specifically, for example, the acquisition unit 601, the setting unit 602, the classification unit 603, the extraction unit 604, the generation unit 605, and the output unit 606 implement their functions by causing the CPU 201 to execute a program stored in a storage area of the memory 202 or the recording medium 205 illustrated in FIG. 2, or by the network I/F 203. The processing result of each functional unit is stored, for example, in a storage area of the memory 202 or the recording medium 205 illustrated in FIG. 2.

The storage unit 600 stores various types of information to be referred to or updated in the processing of each functional unit. The storage unit 600 stores, for example, the feature amount of each of a plurality of paths. The plurality of paths is timing paths that satisfy a predetermined timing constraint. A path is any of a route between registers on a circuit, a route from an input terminal to a register on a circuit, and a route from a register to an output terminal on a circuit. The path is implemented using, for example, elements of an FPGA.

The feature amount of the path includes, for example, a first feature amount related to a coordinate value of an element of the path. The first feature amount is, for example, an amount obtained by statistically processing the coordinate value of the element of the path. Specifically, the first feature amount is an average value of coordinate values of elements of the path. The coordinate value is, for example, a value indicating a position on the FPGA 110, The coordinate value of the element of the path includes a coordinate value of each of two axes of a plane coordinate system. The first feature amount includes an amount obtained by statistically processing the coordinate value of the element of a path for each axis.

In addition, the path feature amount includes a second feature amount that is different from the first feature amount. The second feature amount has no relationship to the coordinate values of the elements of the path. The second feature amount includes at least one of, for example, the number of registers of the path, the number of lookup tables of the path, and the frequency of a signal of the path.

The storage unit 600 stores, for example, a plurality of ranges regarding coordinate values divided into predetermined range units. Each of the plurality of ranges is used as a classification destination of a path based on the first feature amount. Each of the plurality of ranges is a range in which a difference in the first feature amount between paths classified into the same range may be ignored from the viewpoint of signal delay involved in timing analysis, Each of the plurality of ranges is a range in which the influence of the difference in the first feature amount on the signal delay is estimated to be smaller than the influence on the signal delay when the number of logic stages is increased by one. The plurality of ranges includes a range in the plane coordinate system, which is obtained by dividing each of two axes of the plane coordinate system into predetermined range units.

The predetermined range is set based on the increase amount of the first feature amount to satisfy the condition that the amount of increase in signal delay when the first feature amount related to the coordinate value of the element of the path is increased is smaller than the amount of increase in signal delay when the number of logic stages is increased by one. The predetermined range is set, for example, from a range smaller than the increase amount of the first feature amount that satisfies the above condition. The predetermined range may preferably be a relatively large value, for example, in a range smaller than the increase amount of the first feature amount that satisfies the above condition.

The storage unit 600 stores, for example, correspondence information. The correspondence information indicates the increase amount of signal delay when the first feature amount related to the coordinate value of the element of the path increases, in association with each increase amount of the first feature amount. The storage unit 600 stores, for example, the amount of increase in signal delay when the number of logic stages is increased by one.

The storage unit 600 stores, for example, a model. The model outputs the upper limit value of the number of logic stages of a target path when the feature amount of the target path is input. The feature amount input to the model includes, for example, a first feature amount and a second feature amount. The feature amount input to the model may include a range corresponding to the target path among a plurality of ranges instead of the first feature amount. Specifically, the storage unit 600 stores various tables illustrated in FIGS. 3 to 5.

The acquisition unit 601 acquires various types of information used for processing of each functional unit. The acquisition unit 601 stores the acquired various types of information in the storage unit 600, or outputs the information to each functional unit. In addition, the acquisition unit 601 may output various types of information stored in the storage unit 600 to each functional unit. The acquisition unit 601 acquires various types of information, for example, based on a user's operation input. The acquisition unit 601 may receive various types of information, for example, from an apparatus different from the information processing apparatus 100.

Specifically, the acquisition unit 601 may acquire the feature amounts of each of a plurality of paths based on a user's operation input, and may store the acquired feature amounts in the storage unit 600. More specifically, the acquisition unit 601 stores the acquired feature amount of each of the plurality of paths using the path information table 300. Specifically, the acquisition unit 601 may acquire a plurality of ranges which are related to coordinate values and divided into predetermined range units, based on a user's operation input, and store the acquired ranges in the storage unit 600. Specifically, the acquisition unit 601 may acquire a predetermined range based on a user's operation input and store the acquired range in the storage unit 600.

Specifically, the acquisition unit 601 may acquire the correspondence information based on a user's operation input and store the acquired correspondence information in the storage unit 600. More specifically, the acquisition unit 601 stores the acquired correspondence information using the delay information table 400. Specifically, the acquisition unit 601 may acquire the increase amount of signal delay when the number of logic stages is increased by one, based on a user's operation input, and store the acquired increase amount in the storage unit 600. More specifically, the acquisition unit 601 stores the acquired increase amount of signal delay using the threshold information table 500.

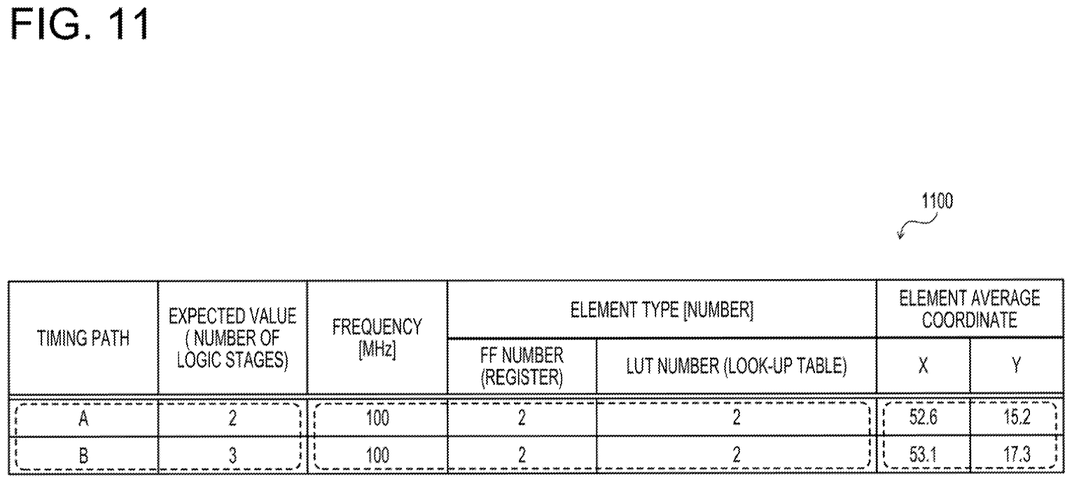

The setting unit 602 sets a predetermined range. The setting unit 602 refers to, for example, the correspondence information to set a predetermined range based on the increase amount of the first feature amount to satisfy the condition that the amount of increase in signal delay when the first feature amount is increased is smaller than the amount of increase in signal delay when the number of logic stages is increased by one. Specifically, the setting unit 602 sets a predetermined range smaller than the increase amount of the first feature amount. An example of setting the predetermined range will be described in detail later with reference to FIGS. 11 to 13. As a result, the setting unit 602 may specify a plurality of ranges.

The setting unit 602 may set a plurality of ranges based on a predetermined range and store the ranges in the storage unit 600. The setting unit 602 sets, for example, a plurality of ranges obtained by dividing coordinate values into predetermined range units, Specifically, the setting unit 602 sets a plurality of ranges in the plane coordinate system obtained by dividing each axis in predetermined range units. As a result, the setting unit 602 may make a range be a classification destination of a plurality of paths available.

The classification unit 603 classifies a plurality of paths into a plurality of classes. The classification unit 603 classifies a plurality of paths into a plurality of ranges, for example, based on the first feature amount of each of the plurality of paths. Then, the classification unit 603 classifies the plurality of paths into a plurality of classes, for example, based on the result of classifying the plurality of paths into the plurality of ranges and the second feature amount of each path.

Specifically, the classification unit 603 classifies a path in which the average value of the coordinate values of elements is included in any of a plurality of ranges, into the corresponding range. Also, specifically, the classification unit 603 classifies a path among the plurality of paths, which is classified into the same range among the plurality of ranges and has the same second feature amount, into the same class among the plurality of classes.

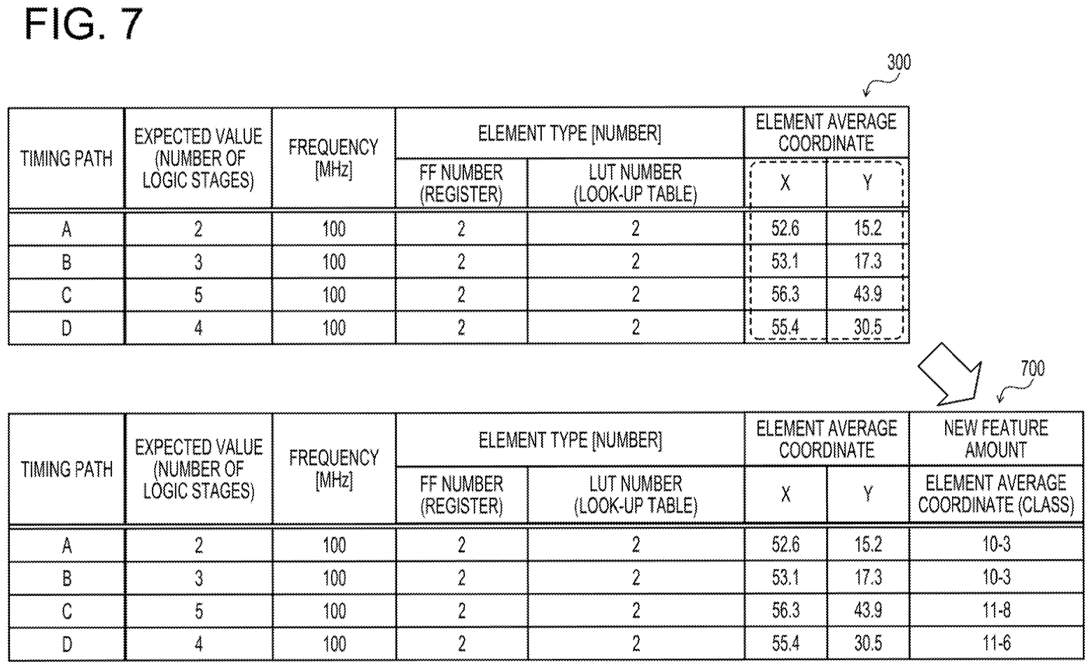

More specifically, when there are paths p11 to p16 in which the X coordinate value is in the first range from the origin of the X axis and the Y coordinate value is in the second range from the origin of the Y axis, among a plurality of paths, the classification unit 603 classifies the paths p11 to p16 into a range (1, 2). Then, more specifically, when the paths p11 to p13 among the paths p11 to p16 classified into the range (1, 2) have the same second feature amount f1, the classification unit 603 classifies the paths p11 to p13 into a class {f1, range (1, 2)}. An example of classifying a plurality of paths into a plurality of classes will be described in detail later with reference to FIGS. 7 to 9.

Thus, the classification unit 603 may ignore a difference between the first feature amounts from the viewpoint of signal delay involved in timing analysis, and combine paths having the same second feature amount into the same class. Therefore, when the classification unit 603 extracts at least a path having the largest number of logic stages from each of a plurality of classes and uses the number of logic stages and the feature amount of the extracted path as teaching data, the model accuracy may be secured.

In addition, for example, the classification unit 603 may classify a plurality of paths into a plurality of groups based on the second feature amount of each path, Next, for example, the classification unit 603 may classify one or more paths for each group into a plurality of ranges based on the first feature amount of each path for one or more paths for each group. Then, for example, the classification unit 603 may classify one or more paths for each group into a plurality of classes based on the result of classifying one or more paths for each group into a plurality of ranges.

Specifically, the classification unit 603 classifies one or more paths having the same second feature amount into the same group. Next, specifically, the classification unit 603 classifies, for each group, paths in which the average value of the coordinate values of elements is included in any of a plurality of ranges, into the corresponding range. Then, specifically, the classification unit 603 sets a result of classifying one or more paths for each group into a plurality of ranges, as a result of classifying one or more paths for each group into a plurality of classes.

More specifically, when paths p21 to p26 among the plurality of paths have the same second feature amount f2, the classification unit 603 classifies the paths p21 to p26 into a group (f2). Here, for example, there may be paths p21 to p23 in which the X coordinate value is in the first range from the origin of the X axis and the Y coordinate value is in the second range from the origin of the Y axis, among the paths p21 to p26 classified into the group (f2). In this case, the classification unit 603 classifies the paths p21 to p23 into a class {f2, range (1, 2)}.

Thus, the classification unit 603 may ignore a difference between the first feature amounts from the viewpoint of signal delay involved in timing analysis, and combine paths having the same second feature amount into the same class. Therefore, when the classification unit 603 extracts at least a path having the largest number of logic stages from each of a plurality of classes and uses the number of logic stages and the feature amount of the extracted path as teaching data, the model accuracy may be secured.

The extraction unit 604 extracts a path having the largest number of logic stages in each of the plurality of classes. For example, when there is a plurality of paths having the largest number of logic stages in a class, the extraction unit 604 may extract any one of the paths having the largest number of logic stages. As a result, the extraction unit 604 may extract a path that adopts the number of logic stages and the feature amount as teaching data appropriately from the viewpoint of securing the model accuracy.

The generation unit 605 generates a model by using the number of logic stages and the feature amount of the extracted path as teaching data. The model outputs the upper limit value of the number of logic stages of a target path according to the feature amount of the target path. The feature amount includes, for example, a first feature amount and a second feature amount. For example, the generation unit 605 generates a model using SVM with the feature amount of the extracted path as input data and the number of logic stages of the extracted path as correct answer data. As a result, the generation unit 605 may generate a model capable of outputting the upper limit value of the number of logic stages of a target path with high accuracy according to the feature amount of the target path.

The output unit 606 outputs the processing result of at least one of the functional units. The output format is, for example, display on a display, print output to a printer, transmission to an external device by the network I/F 203, or storage in a storage area of the memory 202 or the recording medium 205. The output unit 606 outputs, for example, the generated model. Thus, the output unit 606 may make the model available for timing analysis. [Operation Example of Information Processing Apparatus 100]

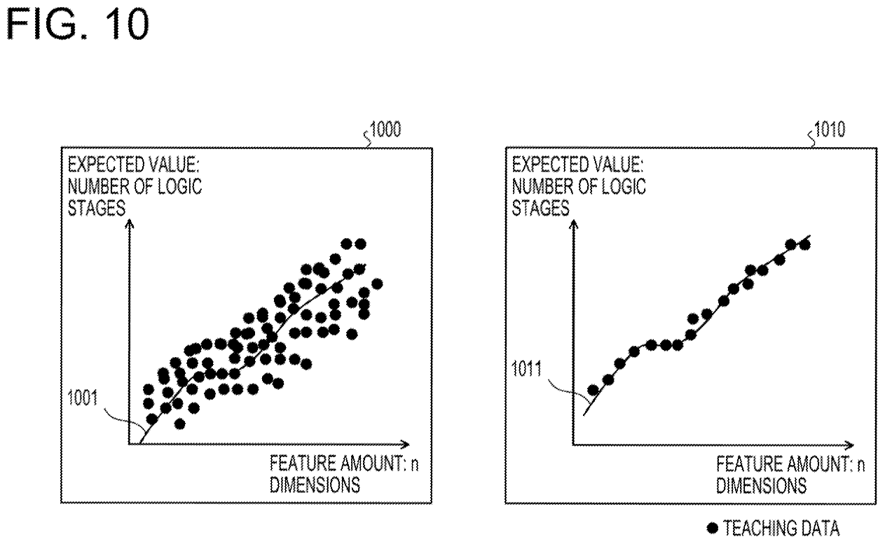

Next, an operation example of the information processing apparatus 100 will be described with reference to FIGS. 7 to 13. Specifically, an example of generating a model will be first described with reference to FIGS. 7 to 9. Next, an example of using the model for timing analysis will be described with reference to FIG. 10. Then, an example of setting a predetermined range used to generate the model will be described with reference to FIGS. 11 to 13, Here, the description will be shifted to the description of FIGS. 7 to 9.

FIGS. 7 to 9 are explanatory views illustrating an example of generating a model. In FIG. 7, the information processing apparatus 100 sets a predetermined range used to generate a model to 5. The predetermined range may be set separately for the X axis and the Y axis. An example of setting the predetermined range will be described in detail later with reference to FIGS. 11 to 13.

The information processing apparatus 100 reads the path information table 300. Here, since paths A to D stored in the path information table 300 satisfy a timing constraint, the number of logic stages and the feature amounts of the paths A to D may be used as teaching data for generating a model.

The process miniaturization tends to increase the influence of the internal structure and internal wiring of the FPGA on signal delay. For this reason, even in the paths A to D of the same frequency and the same element type, when the average value of the coordinate values of the elements is different, the signal delay may be different, and the number of logic stages permitted on the timing constraints may be different Therefore, it is not always possible to generate a model with high accuracy simply by using the number of logic stages and the feature amount of any one of the paths A to D having the same frequency and the same element type as teaching data.

In the meantime, when all the number of logic stages and the feature amounts of the paths A to D are used as teaching data, the processing amount and processing time required for generating a model will be increased. Further, the teaching data does not necessarily include the maximum value of the number of logic stages permitted on the timing constraint, but includes an example of the number of logic stages permitted on the timing constraint. Therefore, the model is generated by learning a representative value of the number of logic stages permitted on the timing constraint instead of the maximum value of the logic stages permitted on the timing constraint, which leads to a decrease in the model accuracy.

Therefore, the information processing apparatus 100 classifies the paths A to D into a range in which a difference in the average value of the coordinate values of elements between the paths may be ignored from the viewpoint of signal delay involved in timing analysis. Thus, the information processing apparatus 100 may obtain an index that specifies the number of logic stages and the feature amount of a path, which may not be used as teaching data from the viewpoint of the average value of the coordinate values of elements between paths.

In the example of FIG. 7, the information processing apparatus 100 converts the average value of the X coordinate values and the average value of the Y coordinate values of the paths A to D into an integer equal to or greater than 0 with respect to the X axis and the Y axis at an interval of predetermined range=5, and classifies the paths A to D into classes related to element average coordinates based on the result of the conversions. For example, a number n related to the X axis corresponds to a range of 5n or more and (5n+1) or less when the X axis is divided by the interval of predetermined range=5. Similarly, a number m related to the Y axis corresponds to a range of 5 m or more and (5 m+1) or less when the Y axis is divided at the interval of predetermined range=5.

Specifically, since the average value “52.6” of the X coordinate values of the path A is included in the range of No. 10, the information processing apparatus 100 converts the average value “52.6” of the X coordinate values of the path A into a number 10. Similarly, the information processing apparatus 100 converts the average value “15.2” of the Y coordinate values of the path A into a number 3. Then, the information processing apparatus 100 classifies the path A into an element average coordinate class identified by a name “10-3” in which the converted numbers are combined. The information processing apparatus 100 stores the name “10-3” as a new feature amount of the path A in the table 700 and stores the result of classifying the path A.

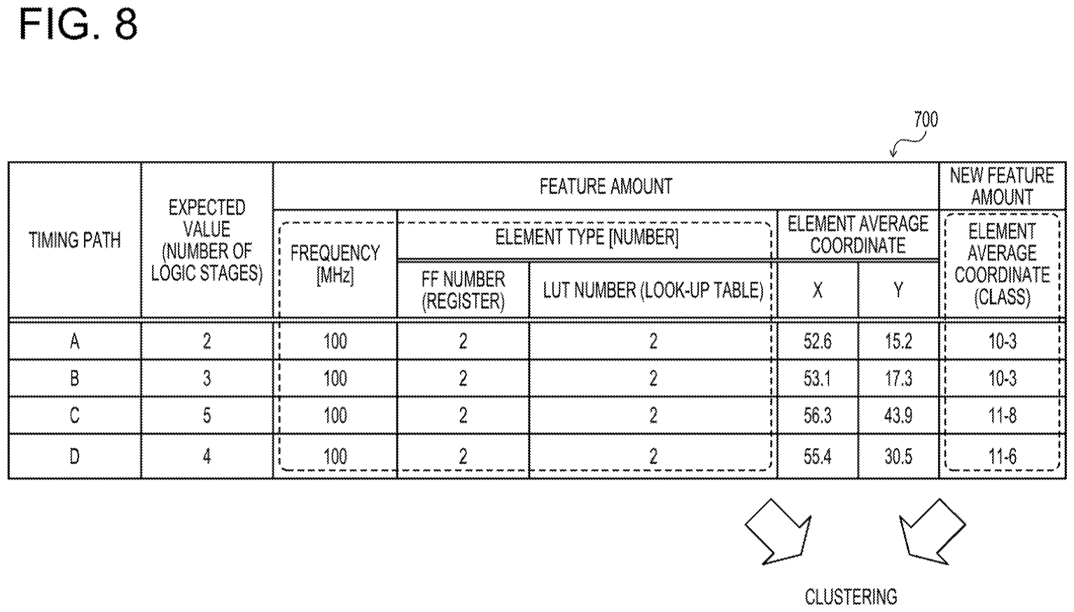

Similarly, the information processing apparatus 100 classifies the path B into an element average coordinate class identified by a name “10-3”. The information processing apparatus 100 stores the name “10-3” as a new feature amount of the path B in the table 700 and stores the result of classifying the path B. Similarly, the information processing apparatus 100 classifies the path C into an element average coordinate class identified by a name “11-8”. The information processing apparatus 100 stores the name “11-8” as a new feature amount of the path C in the table 700 and stores the result of classifying the path C. Similarly, the information processing apparatus 100 classifies the path D into an element average coordinate class identified by a name “11-6”. The information processing apparatus 100 stores the name “11-6” as a new feature amount of the path D in the table 700 and stores the result of classifying the path D. Here, the description will be shifted to the description of FIG. 8.

In FIG. 8, the information processing apparatus 100 further clusters the paths A to D based on the element average coordinate class into which the paths A to D are classified and the feature amounts of the paths A to D. In the example of FIG. 8, for example, the information processing apparatus 100 sets, as a class o, a classification destination of a path having a combination of a name “10-3”, a frequency “100”, a FF number “2”, and a LUT number “2” in association with each other in the table 700.

In addition, for example, the information processing apparatus 100 sets, as a class β, a classification destination of a path having a combination of a name “11-8”, a frequency “100”, an FF number “2”, and a LUT number “2” in association with each other in the table 700. In addition, for example, the information processing apparatus 100 sets, as a class γ, a classification destination of a path having a combination of a name “11-6”, a frequency “100”, a FF number “2”, and a LUT number “2” in association with each other in the table 700.

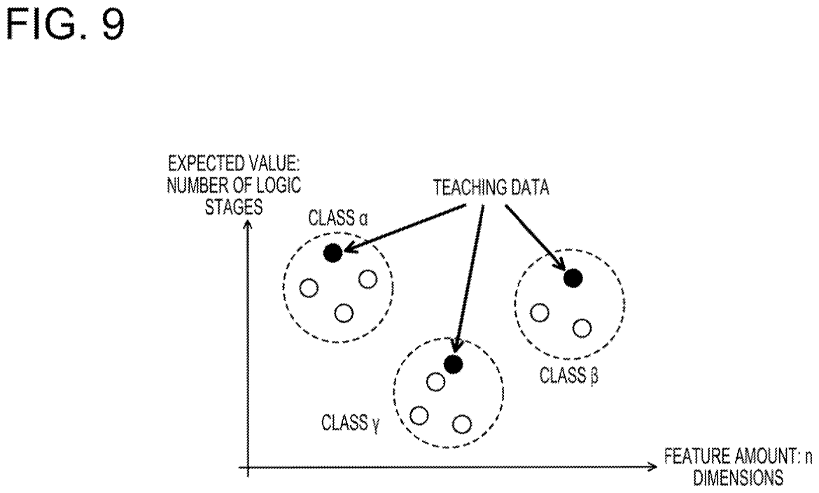

Then, the information processing apparatus 100 classifies the paths A and B, which are classified into an element average coordinate class identified by the same name “10-3” and have the same feature amount, into the class α. Similarly, the information processing apparatus 100 classifies the path C into the class β. Similarly, the information processing apparatus 100 classifies the path D into the class γ. As a result, the information processing apparatus 100 may obtain an index that specifies the number of logic stages and the feature amount of a path, which may not be used as teaching data. Here, the description will be shifted to the description of FIG. 9.

In FIG. 9, the information processing apparatus 100 extracts, for each class, a path having the largest number of logic stages. Here, for example, from the viewpoint of signal delay involved in timing analysis, a class may ignore a difference in average value of element coordinate values between paths, and the paths having the same feature amount are classified. For this reason, the number of logic stages and the feature amount of a path in which the number of logic stages is not the largest in a class do not cause deterioration in the model accuracy even when not set as teaching data. Rather, the number of logic stages and the feature amount of the path in which the number of logic stages is not the largest in the class α may cause deterioration in the model accuracy when set as teaching data.

Therefore, for example, the information processing apparatus 100 extracts one path in which the number of logic stages is the largest, from the class α, and sets the number of logic stages and the feature amount of the extracted path as teaching data. Here, the information processing apparatus 100 does not set the number of logic stages and the feature amount of a path that is not extracted, as teaching data. Similarly, for example, the information processing apparatus 100 extracts one path in which the number of logic stages is the largest, from the class β, and sets the number of logic stages and the feature amount of the extracted path as teaching data. Similarly, for example, the information processing apparatus 100 extracts one path in which the number of logic stages is the largest, from the class γ, and sets the number of logic stages and the feature amount of the extracted path as teaching data.

Thus, the information processing apparatus 100 may efficiently generate a model capable of outputting the upper limit value of the number of logic stages of a target path with high accuracy according to the feature amount of the target path. For example, the information processing apparatus 100 may reduce the number of teaching data used to generate a model and may reduce the processing amount and processing time required to generate the model. The information processing apparatus 100 may also reduce the power consumption required to generate the model. Here, the description will be shifted to the description of FIG. 10.

FIG. 10 is an explanatory view illustrating an example of using a model for timing analysis. In FIG. 10, a graph 1000 indicates a model 1001 that is generated by an apparatus of the related art using SVM to set the number of logic stages and the feature amount of each of a plurality of paths as teaching data. In the figure, the symbol “•” indicates teaching data. In this case, the apparatus of the related art generates a model by learning a representative value of the number of logic stages permitted on the timing constraint, instead of the maximum value of the number of logic steps permitted on the timing constraint, for any feature amount.

For this reason, as illustrated in the graph 1000, the model 1001 may not output the maximum value of the number of logic stages permitted on the timing constraint according to any one feature amount. As a result, when the model 1001 is used for timing analysis, there is a possibility that it may be determined that the timing constraint is not satisfied for a path that actually satisfies the timing constraint.

Therefore, the apparatus of the related art may not reduce the processing amount and processing time required to generate a model and may cause a decrease in the accuracy of timing analysis. For example, the apparatus of the related art may require an analyst to consider a path that actually satisfies the timing constraint, which may lead to an increase in the workload and work time of the analyst.

In contrast, the information processing apparatus 100 may extract certain paths from a plurality of paths and may generate a model using SVM to set the number of logic stages and the feature amounts of the extracted paths as teaching data. A graph 1010 indicates a model 1011 generated by the information processing apparatus 100. In the figure, the symbol “•” indicates teaching data. In this case, the information processing apparatus 100 may generate a model by learning the maximum value of the number of logic stages permitted on the timing constraint for any one feature amount.

Therefore, as illustrated in the graph 1010, the model 1011 is an accurate model capable of outputting the maximum value of the number of logic stages permitted on the timing constraint according to any one feature amount. As a result, when the model 1011 is used for timing analysis, it may be determined with high accuracy whether a path satisfies the timing constraint. Further, the information processing apparatus 100 may reduce the processing amount and processing time required to generate a model.

FIGS. 11 to 13 are explanatory views illustrating an example of setting a predetermined range. In FIG. 11, certain records of the path information table 300 are illustrated as an example in a table 1100, The paths A and B have the same frequency, element type, etc., but have different element average coordinates.

As described above, even in paths of the same frequency and the same element type, when the average value of the coordinate values of elements is different, the signal delay may be different, and the number of logic stages permitted on the timing constraints may be different, Meanwhile, as described above, when a difference in average value of the coordinate values of the elements between paths falls within a certain range, the difference in average value of the coordinate values of the elements between paths may be ignored from the viewpoint of signal delay involved in timing analysis.

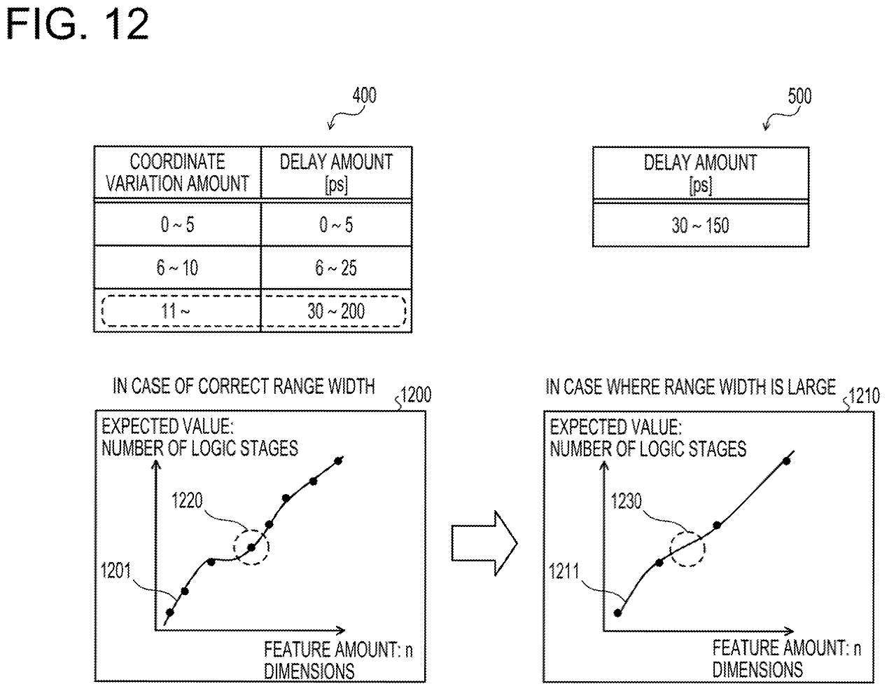

Therefore, it is desirable to define accurately whether the difference in average value of the coordinate values of the elements between the paths A and B has a negligible size from the viewpoint of signal delay involved in the timing analysis or has a size influencing on the number of logic stages permitted on the timing constraint. Specifically, the information processing apparatus 100 defines a range in which the difference in average value of the coordinate values of the elements between the paths may be ignored from the viewpoint of signal delay involved in the timing analysis, by a predetermined range. Here, the description will be shifted to the description of FIG. 12.

In FIG. 12, the information processing apparatus 100 refers to the delay information table 400 and the threshold information table 500 to set a predetermined range. The threshold information table 500 represents that, when the number of logic stages is increased by one, the delay amount increases in the range of 30 to 150 [ps], at the minimum of 30 [ps]. Further, the delay information table 400 represents that, when the average value of the coordinate values of the elements increases in the range of 6 to 10, the delay amount increases by 6 to 25 [ps], at the maximum of 25 [ps].

Here, even when the average value of the coordinate values of the elements increases in the range of 6 to 10 and the delay amount increases by 25 [ps], this delay amount becomes smaller than the increase amount 30 [ps] of the delay amount for one logic stage. In other words, even when the average value of the coordinate values of the elements increases in the range of 6 to 10, the number of logic stages is not affected. Therefore, when the difference between the average values of the coordinate values of the elements is 10 or less, it is determined that the difference between the average values of the coordinate values of the elements may be ignored from the viewpoint of signal delay involved in the timing analysis.

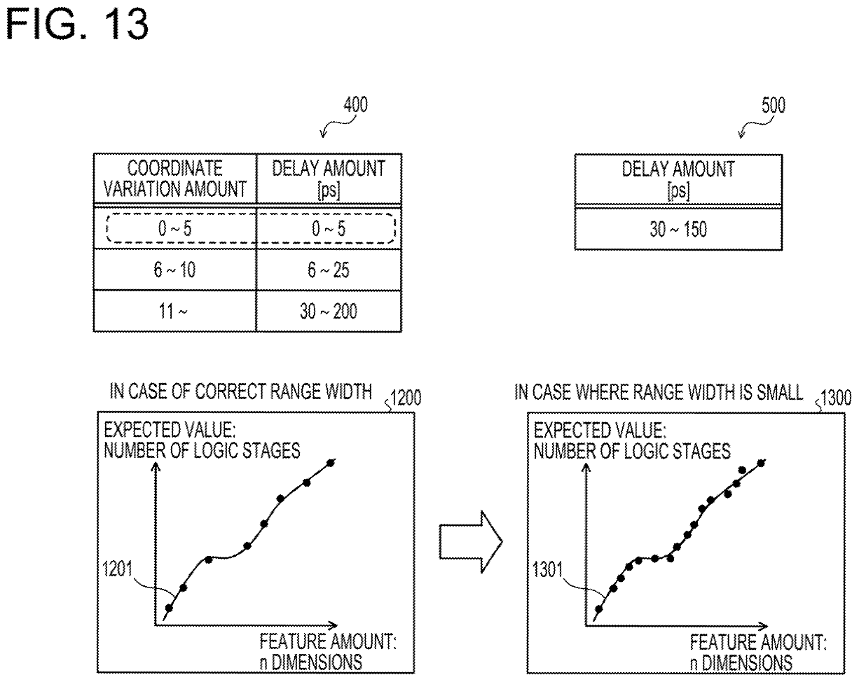

Therefore, in the example of FIG. 12, the information processing apparatus 100 sets the predetermined range to 10. Specifically, the information processing apparatus 100 may set the predetermined range within a range smaller than the maximum value of the increase amount of the average value of the coordinate values of the elements that satisfy the following formula (1). Further, it is preferable that the predetermined range is a relatively large value within a range smaller than the maximum value of the increase amount of the average value of the coordinate values of the elements that satisfy the following formula (1). The reason why a relatively large value is preferable will be described later with reference to FIG. 13.

[Maximum value of increase amount of delay amount according to increase amount of average value of coordinate values of elements]≤[Minimum value of increase amount of delay amount for one logic stage] (1)

In the following description, the predetermined range=10 may be written as a “correct range”. A graph 1200 represents a model 1201 generated by the information processing apparatus 100 using the correct range. In the figure, the symbol “•” indicates teaching data. In this case, since the information processing apparatus 100 sets the correct range, it is possible to generate a model with high accuracy while reducing the number of teaching data.

Here, descriptions will be made on a case where an incorrect range which is larger than the maximum value of the increase amount of the average value of the coordinate values of the elements satisfying the above-mentioned formula (1) is set to the predetermined range. The delay information table 400 represents that, when the average value of the coordinate values of the elements increases within a range of 11 or more, the delay amount increases by 30 to 200 [ps], at the maximum of 200 [ps].

Here, when the average value of the coordinate values of the elements increases in the range of 11 or more and the delay amount increases by 30 to 200 [ps], this delay amount is larger than the increase amount 30 [ps] of the delay amount for one logic stage. In other words, when the average value of the coordinate values of the elements increases in the range of 11 or more, the number of logic stages may be affected. Therefore, when the difference between the average values of the coordinate values of the elements is 11 or larger, the difference between the average values of the coordinate values of the elements may not be ignored from the viewpoint of signal delay involved in the timing analysis. Therefore, the range of 11 or more is determined to be an incorrect range.

For example, when the incorrect range 11 is used, a model 1211 illustrated in a graph 1210 is generated. In the figure, the symbol “•” indicates teaching data. In this case, since the incorrect range is set, teaching data that is preferably used are reduced, which may result in generation of a model with low accuracy.

For example, in the model 1201 based on the correct range, the maximum value of the number of logic stages permitted on the timing constraint may be output with high accuracy for the path feature amount at a position indicated by reference numeral 1220. In the meantime, in the model 1211 based on the incorrect range, there is a possibility that the number of logic stages not permitted on the timing constraint is output for the path feature amount at a position indicated by reference numeral 1230s Next, the description will be shifted to the description of FIG. 13.

In FIG. 13, a graph 1200 represents a model 1201 generated by the information processing apparatus 100 using the correct range. In the figure, the symbol “•” indicates teaching data. The graph 1200 is similar to that of FIG. 12, In this case, since the information processing apparatus 100 sets the correct range, it is possible to generate a model with high accuracy while reducing the number of teaching data.

Here, descriptions will be made on a case where a relatively small value is set to the predetermined range within a range smaller than the maximum value of the increase amount of the average value of the coordinate values of the elements satisfying the above-mentioned formula (1). The delay information table 400 represents that, when the average value of the coordinate values of the elements increases within a range of 0 to 5, the delay amount increases by 0 to 5 [ps], at the maximum of 5 [ps].

Here, even when the average value of the coordinate values of the elements increases in the range of 0 to 5 and the delay amount increases by 0 to 5 [ps], this delay amount is smaller than the increase amount 30 [ps] of the delay amount for one logic stage. In other words, even when the average value of the coordinate values of the elements increases in the range of 0 to 5, the number of logic stages is not affected. Therefore, when the difference between the average values of the coordinate values of the elements is 5 or smaller, it is determined that the difference between the average values of the coordinate values of the elements may be ignored from the viewpoint of signal delay involved in the timing analysis.

Therefore, it may be considered that the information processing apparatus 100 sets the predetermined range to 5. However, in this case, when the difference between the average values of the coordinate values of the elements is 6 to 10, it is determined that the difference between the average values of the coordinate values of the elements may not be ignored. As a result, based on the predetermined range=5, the information processing apparatus 100 may use teaching data which may secure the model accuracy without actually using such data, to generate a model.

For example, a range 5 is used to generate a model 1301 illustrated in a graph 1300. In the figure, the symbol “•” indicates teaching data. In this case, since the range 5 is set, teaching data which may secure the model accuracy without actually using such data may be used to generate the model. As a result, the degree of reduction in the processing amount and processing time required to generate the model is smaller than that when the correct range is set. From this, it is preferable that the predetermined range is a relatively large value within a range smaller than the maximum value of the increase amount of the average value of the coordinate values the elements satisfying the above-mentioned formula (1).

[Entire Processing Procedure]

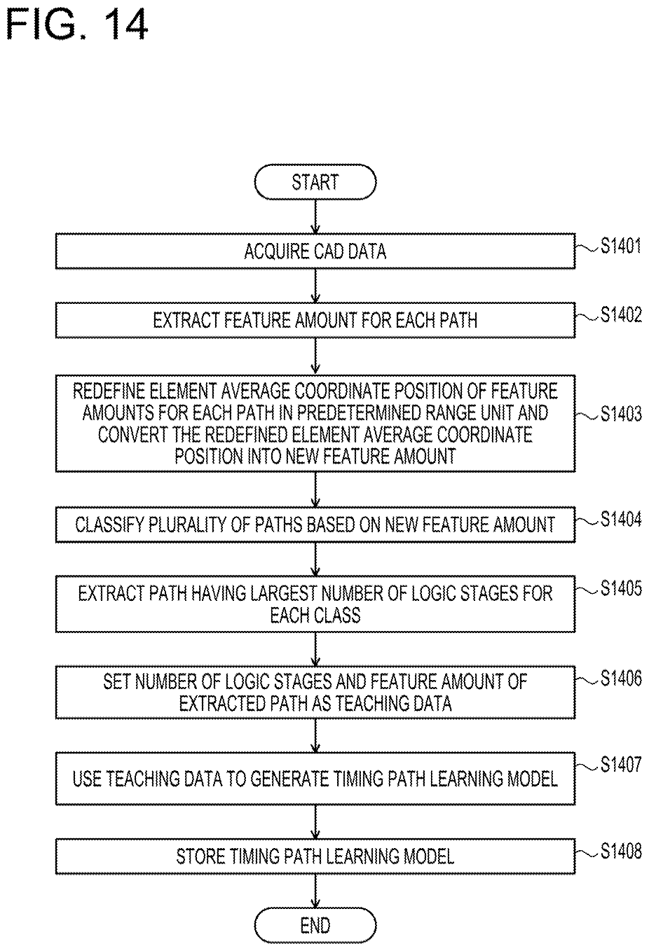

Next, an example of the entire processing procedure executed by the information processing apparatus 100 will be described with reference to FIG. 14. The entire processing procedure is implemented by, for example, the CPU 201, the storage area of the memory 202 or the recording medium 205, and the network I/F 203, which are illustrated in FIG. 2.

FIG. 14 is a flowchart illustrating an example of the entire processing procedure. In FIG. 14, the information processing apparatus 100 acquires Computer Aided Design (CAD) data that defines a path (operation 51401). Next, the information processing apparatus 100 extracts feature amounts for each path based on the CAD data, and stores the extracted feature amounts in the path information table 300 (operation S1402), Then, based on the path information table 300, the information processing apparatus 100 redefines an element average coordinate of the feature amounts for each path in a predetermined range unit and converts the redefined element average coordinate into a new feature amount (operation S1403).

Next, the information processing apparatus 100 classifies a plurality of paths into a plurality of classes based on the feature amounts of the path information table 300 and the converted new feature amount (operation S1404), Then, the information processing apparatus 100 extracts, for each class, a path having the largest number of logic stages (operation S1405), Next, the information processing apparatus 100 sets the number of logic stages and the feature amount of the extracted path as teaching data (operation S1406). Then, the information processing apparatus 100 uses the teaching data to generate a timing path learning model (operation S1407).

Next, the information processing apparatus 100 stores the timing path learning model (operation S1408), Then, the information processing apparatus 100 ends the entire processing procedure. Thus, the information processing apparatus 100 may efficiently generate a timing path learning model. Then, the information processing apparatus 100 may make the timing path learning model available for timing analysis. As a result, the information processing apparatus 100 may improve the accuracy of timing analysis.

As described above, according to the information processing apparatus, a plurality of paths may be classified into a plurality of ranges regarding coordinate values divided in predetermined range units, based on the first feature amount of each of the plurality of paths. According to the information processing apparatus, the plurality of paths may be classified into a plurality of classes based on the result of classifying the plurality of paths into the plurality of ranges and the second feature amount of each path. According to the information processing apparatus, it is possible to extract a path having the largest number of logic stages in each of the plurality of classes. According to the information processing apparatus, it is possible to generate a model that outputs the upper limit value of the number of logic stages of a target path according to the feature amount of the target path, using the number of logic stages and the feature amount of the extracted path as teaching data. As a result, the information processing apparatus may efficiently generate a model capable of outputting the upper limit value of the number of logic stages in the target path with high accuracy according to the feature amount of the target path.

According to the information processing apparatus, a predetermined range may be set based on the increase amount of the first feature amount satisfying the condition that the increase amount of signal delay when the first feature amount is increased is smaller than the increase amount of signal delay when the number of logic stages is increased by one. Thus, the information processing apparatus may reduce the number of teaching data within a range that may secure the model accuracy.

According to the information processing apparatus, it is possible to use an amount obtained by statistically processing the coordinate value of an element of a path, as the first feature amount of the path. Thus, even when the coordinate value of the element of the path has an outlier, the information processing apparatus may easily consider the influence of the variation of the element coordinate value of the path on the delay amount.

According to the information processing apparatus, a coordinate value of each of two axes of a plane coordinate system may be included in a coordinate value of an element of a path. According to the information processing apparatus, an amount obtained by statistically processing the coordinate value of the element of the path for each axis may be included in the first feature amount of the path. According to the information processing apparatus, a range in the plane coordinate system obtained by dividing each axis in predetermined range units may be included in a plurality of ranges. Thus, the information processing apparatus may be made applicable to the coordinate values of the plane coordinate system.

According to the information processing apparatus, at least one of the number of registers of a path, the number of lookup tables of the path, and the frequency of a signal of the path may be included in the second feature amount of the path. Thus, the information processing apparatus may make it possible to consider feature amounts such as the number of path registers, the number of path lookup tables, and the frequency of path signals, which affect delay.

According to the information processing apparatus, paths satisfying a predetermined timing constraint may be used as a plurality of paths. Thus, the information processing apparatus may make the number of logic stages and the feature amount of each of the plurality of paths be information preferable as teaching data, without using paths that do not satisfy the predetermined timing constraint.

According to the information processing apparatus, a process of classifying a plurality of paths into a plurality of classes may classify paths which are classified into the same range among the plurality of ranges and have the same second feature amount, among the plurality of paths, into the same class among the plurality of classes. Thus, the information processing apparatus may classify a plurality of paths into a plurality of classes so as to easily specify teaching data which is not required to be used.

According to the information processing apparatus, a plurality of paths may be classified into a plurality of groups based on the second feature amount of each path. According to the information processing apparatus, it is possible to classify one or more paths for each group into a plurality of ranges based on the first feature amount of each path for one or more paths for each group. According to the information processing apparatus, it is possible to classify one or more paths for each group into a plurality of classes based on a result of classifying one or more paths for each group into a plurality of ranges. Thus, the information processing apparatus may efficiently generate a model capable of outputting the upper limit value of the number of logic stages of a target path with high accuracy according to the feature amount of the target path.

According to the information processing apparatus, any one of a route between registers on a circuit, a route from an input terminal to a register on the circuit, and a route from a register to an output terminal on the circuit may be used as a path. Thus, the information processing apparatus may generate a model using the route between registers on a circuit, the route from an input terminal to a register on the circuit, and the route from a register to an output terminal on the circuit.

Further, the generation method described in the present embodiment may be implemented by executing a prepared program on a computer such as a personal computer or a workstation. The generation program described in the present embodiment is recorded on a computer-readable recording medium such as a hard disk, a flexible disk, a CD-ROM, an MO, and a DVD, and is executed by being read from the recording medium by the computer. In addition, the generation program described in the present embodiment may be distributed via a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a memory; and
a processor coupled to the memory and configured to:
classify a plurality of paths into a plurality of ranges which are divided in a predetermined range unit and related to a coordinate value, based on a first feature amount that includes the coordinate value of a path of the plurality of paths;
classify the plurality of paths into a plurality of classes, based on a result of classifying the plurality of paths into the plurality of ranges and a second feature amount that includes a number of registers of the path;
extract the path that has a maximum number of logic stages in each of the plurality of classes; and
generate a timing path learning model that outputs a maximum limit value of a number of logic stages of a target path according to the first feature amount of the target path, based on training data that includes the number of logic stages and the first feature amount of the extracted path.

2. The information processing apparatus according to claim 1,
wherein the processor is further configured to:
set the predetermined range unit based on an increase amount of the first feature amount that satisfies a condition that the increase amount of signal delay when the first feature amount is increased is smaller than the increase amount of signal delay when the number of logic stages is increased by one.

3. The information processing apparatus according to claim 1,
wherein the first feature amount is an amount obtained by statistically processing the coordinate value of the path.

4. The information processing apparatus according to claim 3,
wherein the coordinate value of the path includes a coordinate value of each of two axes of a plane coordinate system, and the first feature amount includes an amount obtained by statistically processing the coordinate value of the path for each axis, and
wherein the plurality of ranges include a range in the plane coordinate system obtained by dividing each axis in the predetermined range unit.

5. The information processing apparatus according to claim 1,
wherein the second feature amount includes at least one of the number of registers of the path, a number of lookup tables of the path, and a frequency of a signal of the path.

6. The information processing apparatus according to claim 1,
wherein the plurality of paths are timing paths that satisfy a predetermined timing constraint.

7. The information processing apparatus according to claim 1,
wherein when classifying the plurality of paths into the plurality of classes, the processor is configured to classify paths which are classified into a range among the plurality of ranges and have a same second feature amount, among the plurality of paths, into a class among the plurality of classes.

8. The information processing apparatus according to claim 1,
wherein the processor is further configured to:
classify the plurality of paths into a plurality of groups based on the second feature amount;
classify one or more paths in a group of the plurality of groups into the plurality of ranges based on the first feature amount; and
classify the one or more paths in the group into the plurality of classes based on a result of classifying the one or more paths in the group into the plurality of ranges.

9. The information processing apparatus according to claim 1,
wherein the path is implemented in an element, and the path is any of a route between registers on a circuit in the element, a route from an input terminal to a register on the circuit, and a route from a register to an output terminal on the circuit.

10. The information processing apparatus according to claim 1,
wherein the predetermined range is set based on an increase amount of the first feature amount that satisfies a condition that an increase amount of signal delay when the first feature amount is increased is smaller than the increase amount of signal delay when the number of logic stages is increased by one.

11. A generation method of a timing path learning model comprising:
classifying a plurality of paths into a plurality of ranges which are divided in a predetermined range unit and related to a coordinate value, based on a first feature amount that includes the coordinate value of a path of the plurality of paths;
classifying the plurality of paths into a plurality of classes, based on a result of classifying the plurality of paths into the plurality of ranges and a second feature amount that includes a number of registers of the path;
extracting the path that has a maximum number of logic stages in each of the plurality of classes; and
generating the timing path learning model that outputs a maximum limit value of a number of logic stages of a target path according to the first feature amount of the target path, based on training data that includes the number of logic stages and the first feature amount of the extracted path, by a processor.

12. A computer-readable non-transitory recording medium having stored therein a program that causes a computer to execute a procedure, the procedure comprising:
classifying a plurality of paths into a plurality of ranges which are divided in a predetermined range unit and related to a coordinate value, based on a first feature amount that includes the coordinate value of a path of the plurality of paths;
classifying the plurality of paths into a plurality of classes, based on a result of classifying the plurality of paths into the plurality of ranges and a second feature amount that includes a number of registers of the path;
extracting the path that has a maximum number of logic stages in each of the plurality of classes; and
generating a timing path learning model that outputs a maximum limit value of a number of logic stages of a target path according to the first feature amount of the target path, based on training data that includes the number of logic stages and the first feature amount of the extracted path.
